(19) United States
(12) Patent Application Publication
(10) Pub. No.: US 2022/0292369 A1
(43) Pub. Date: Sep. 15, 2022

(54) METHOD, DEVICE AND MEDIUM FOR DATA PROCESSING

(71) Applicant: NEC CORPORATION, Tokyo (JP)

(72) Inventors: Wenhao BIAN, Beijing (CN); Wenjuan Wei, Beijing (CN); Lu Feng, Beijing (CN)

(73) Assignee: NEC CORPORATION, Tokyo (JP)

(21) Appl. No.: 17/692,513

(22) Filed: Mar. 11, 2022

(30) Foreign Application Priority Data
Mar. 12, 2021 (CN) 202110272269.5

(51) Int. Cl. G06N 5/02

(52) U.S. Cl. CPC G06N 5/022

(57) ABSTRACT

Embodiments of the present disclosure relate to a method, device and computer-readable storage medium for data processing. A method for data processing comprises: obtaining observed data corresponding to a plurality of factors to be analyzed; in response to one of the plurality of factors being selected as a target factor, obtaining a causal structure of the plurality of factors, the causal structure indicating causal relationships between the plurality of factors; and determining a contribution degree of a first factor of the plurality of factors to target observed data of the target factor based on the causal structure and the observed data corresponding to the plurality of factors. This solution can effectively quantify specific degrees of impact of the respective factors in the causal relationships to current observed data of the target factor, which is beneficial to analysis and policy establishment in various application scenarios.

### BACKGROUND

Embodiments of the present disclosure generally relate to the field of data processing, and more specifically, to a method, device and computer-readable storage medium for data processing.

With the fast development of information technology, the scale of data has grown rapidly. In this context and trend, machine learning is drawing more and more attentions. Causal discovery helps people to get knowledge of the happening mechanism of things and thus has a wide range of applications in real life, such as in the supply chain, healthcare and retail fields. The so-called “causal discovery” here refers to discovering, from data related to a plurality of factors, a causal relationship between the plurality of factors. For example, in the retail field, the result of causal discovery can be used to assist in establishing various sales policies; in the medical and health field, the result of causal discovery can be used to assist in establishing treatment plans for patients, and so on. On the basis of the analyzed a causal relationship between a plurality of factors, the problem is how to use the causal relationship to perform in-depth analysis, which is worthy of attention and needs to be solved.

### SUMMARY

Embodiments of the present disclosure provide a method, device and computer-readable storage medium for data processing.

In a first aspect of the present disclosure, there is provided a method for data processing. The method comprises: obtaining observed data corresponding to a plurality of factors to be analyzed; in response to one of the plurality of factors being selected as a target factor, obtaining a causal structure of the plurality of factors, the causal structure indicating a causal relationship between the plurality of factors; and determining a contribution degree of a first factor of the plurality of factors to target observed data of the target factor based on the causal structure and the observed data corresponding to the plurality of factors.

In a second aspect of the present disclosure, there is provided an electronic device. The device comprises: at least one processing unit; at least one memory coupled to the at least one processing unit and storing instructions executable by the at least one processing unit, the instructions, when executed by the at least one processing unit, causing the device to perform the method according to the first aspect of the present disclosure.

In a third aspect of the present disclosure, there is provided a computer-readable storage medium. The computer-readable storage medium comprises computer-executable instructions stored thereon which are executed by a processor to perform the method according to the first aspect of the present disclosure.

In a fourth aspect of the present disclosure, there is provided a computer program product, comprising a computer program/instructions which, when executed by a processor, perform(s) the method according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure. Other features of the present disclosure will become easy to understand from the description below.

### BRIEF DESCRIPTION OF THE DRAWINGS

Through the following disclosure and claims, the objects, advantages and other features of the present invention will become more apparent. For the purpose of illustration only, non-limiting description of preferable embodiments is provided with reference to the accompanying drawings, where:

FIG. 1 illustrates a block diagram of a data processing system according to some embodiments of the present disclosure;

FIG. 2 illustrates a flowchart of a method for attribution analysis according to some embodiments of the present disclosure;

FIG. 3 illustrates an example causal structure according to some embodiments of the present disclosure;

FIG. 4 illustrates a block diagram of an attribution analysis apparatus according to some embodiments of the present disclosure;

FIG. 5 illustrates a flowchart of an example method for causal point attribution analysis according to some embodiments of the present disclosure;

FIG. 6 illustrates a flowchart of an example method for determining base data of a factor according to some embodiments of the present disclosure;

FIG. 7 illustrates an example of presenting a result of causal point attribution analysis in a causal structure according to some embodiments of the present disclosure;

FIG. 8A illustrates a flowchart of an example method for causal edge attribution analysis according to some embodiments of the present disclosure;

FIG. 8B illustrates a flowchart of an example method for causal edge attribution analysis according to some further embodiments of the present disclosure;

FIG. 9 illustrates an example of presenting a result of causal edge attribution analysis in a causal structure according to some embodiments of the present disclosure;

FIGS. 10A to 10E each illustrate a visual graph of example attribution analysis according to some embodiments of the present disclosure; and

FIG. 11 illustrates a schematic block diagram of an example device which is applicable to implement the embodiments of the present disclosure.

Throughout the figures, the same or corresponding numerals represent the same or corresponding parts.

### DETAILED DESCRIPTION OF EMBODIMENTS

The embodiments will be described in more detail with reference to the accompanying drawings in which some embodiments of the present disclosure have been illustrated. However, the present disclosure can be implemented in various manners, and thus should not be construed to be limited to embodiments disclosed herein. Rather, those embodiments are provided for the thorough and complete understanding of the present disclosure. It should be appreciated that the drawings and embodiments of the present disclosure are only used for illustration, rather than limiting the protection scope of the present disclosure.

The terms “comprise” and its variants used herein are to be read as open terms that mean “include, but is not limited to.” The term “based on” is to be read as “based at least in part on.” The term “one embodiment” or “the embodiment” is to be read as “at least one embodiment.” The terms “first,” “second” and the like may refer to different or the same objects. Other definitions, explicit and implicit, might be included below.

In the embodiments of the present disclosure, the term “causal structure” generally refers to a structure for describing causal relationships between multiple factors in a system. The term “factor” is also referred to as “variable.” The term “observed data” refers to data which can be directly observed for a factor (variable). In some examples, observed data may be in the form of a value, and thus may also be referred to as “observed value.”

In a causal structure, a first factor can be a cause of a second factor, and the second factor can be a result of the first factor. Here, the first factor is referred to as a cause factor (or a causal variable) of the second factor, and the second factor is referred to as an effect factor of the first factor. For a certain factor, there may be one or more factors as its cause factor(s), and also it may be an effect factor of one or more factors. If a change in observed data of one factor directly affects observed data of another factor, then the factor may be referred to as a “direct cause” of the other factor. If one factor affects observed data of another factor via one or more other factors, then the factor may be referred to as an “indirect cause” of the other factor. In the causal structure, a factor may not have any cause factor but may only be a cause factor of other factor(s), or may not have any effect factor but may only be an effect factor of other factor(s).

As described above, in real life, a causal relationship discovery is meaningful in many practical fields.

In the field of customer service, in order to determine which factors will affect customer satisfaction with telecom operators, a large scale of customer consumption behavior data (such as an age of the customer, monthly consumption of Internet traffic, the ratio of free traffic, total monthly consumption of Internet traffics, and the like), satisfaction survey data and operator policy data can be collected. The collected data of each type is also referred to as observed data of a factor (or variable). Through causal relationship discovery between these factors, it is possible to determine one or more factors that affect the customer satisfaction. Further, it is possible to improve the customer satisfaction with telecom operators by changing observed data of one or more factors or establishing a corresponding policy for the one or more factors.

In the health field, in order to determine factors affecting the blood pressure of a patient, a series of physiological indicators (i.e., observed data of a series of factors) of a large number of patients can be collected, such as the heart rate, cardiac output, allergy indicators, total peripheral vascular resistance, catecholamine release, blood pressure, and the like. Through causal relationship discovery between these physiological indicators, it is possible to determine the physiological indicator(s) (i.e., factor(s)) that affects the blood pressure of the patient. Further, it is possible to maintain a stable blood pressure for the patient by affecting the physiological indicator(s) or establishing a corresponding policy for the physiological indicator(s).

In the field of commodity sales, in order to determine factors affecting sales of a target commodity, a scale of factor data may be collected, such as commodity promotion investment, commodity display investment, sales staff investment, advertising investment, new commodity marketing investment, and the like. Other factor data related to the target commodity (e.g., the price of the commodity, the investment in the advertising media of the commodity) may be collected. The collected data of each type is used as observed data of a corresponding factor. Through causal relationship discovery between these factors, it is possible to determine one or more factors that affect the sales of the target commodity. Further, it is possible to increase the sales of the target commodity and plan expenditures of different items by changing observed data of the one or more factors or establishing a corresponding policy for the one or more factors.

In the field of software development, in order to determine factors affecting the failure rate and/or the software development cycle, information about various factors of software development can be collected, including but not limited to overall information about software development (such as the development cycle, resources invested in development, and the like) and information about various stages of software development. The information about the stages of software development may include, for example, information about an architecture stage (such as the software architecture method, the number of software architecture levels, and the like), information about a coding stage (such as the code length, the number of functions, the programming language, the number of modules, and the like), information about a testing stage (such as the correct rate or failure rate of unit testing, the correct rate or failure rate of black box testing, the correct rate or failure rate of white box testing, and the like), information about a running stage after the software is released (such as the correct rate or failure rate of the running stage, and the like) The collected data of each type is used as observed data of a factor. Through causal relationship discovery between these factors, it is possible to determine one or more factors that affect the software development cycle and/or failure rate. Further, it is possible to reduce the software development cycle and/or failure rate by changing observed data of the one or more factors or establishing a corresponding policy for the one or more factors.

Currently, many manual or automatic algorithms have been proposed to discover causal relationships between a plurality of factors. The causal relationships between the plurality of factors may be represented by a specific causal structure. From the causal structure, it is possible to determine which factor(s) affect(s) a certain factor and how these factors affect each other (e.g., indicated by the causal relationships). However, in many applications, it may be further desirable to utilize the causal structure to perform analysis on current observed data of the respective factors, so as to provide guidance on subsequent appropriate policies.

However, there is currently no suitable technical solution that can be applied to determine specific contribution degrees of the respective factors to a certain effect factor in the causal structure.

According to the embodiments of the present disclosure, a solution is proposed for data processing. This solution utilizes a causal structure of a plurality of factors to automatically decompose specific contribution degrees of one or more factors to target observed data of a target factor, given observed data corresponding to each of the factors. Through this solution, it is possible to effectively measure a contribution of a factor or a causal relationship between factors to the observed data of the target factor. The solution can effectively quantify the specific contribution degree of each factor having a causal relationship to the current observed data of the target factor, which is conducive to the analysis and policy establishment in various application scenarios.

Detailed description of various embodiments of the present disclosure is presented below with reference to the above example scenarios. It should be appreciated that this is merely for the illustration purpose and not intended to limit the scope of the present invention in any way.

### Example System

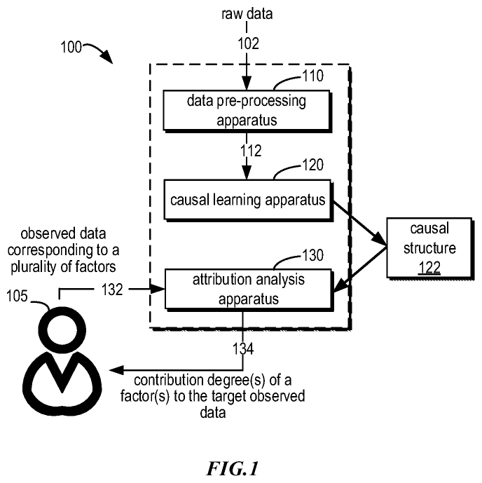

FIG. 1 illustrates an example block diagram of a data processing system 100 according to the embodiments of the present disclosure. It should be appreciated that the data processing system 100 shown in FIG. 1 is merely one example where the embodiments of the present disclosure may be implemented, but is not intended to limit the scope of the present disclosure. The embodiments of the present disclosure are also applicable to other system or architecture. As shown in FIG. 1, the data processing system 100 comprises a data pre-processing apparatus 110, a causal learning apparatus 120 and an attribution analysis apparatus 130.

The data pre-processing apparatus 110 is configured to pre-process raw data 102, and provide the pre-processed data to the causal learning apparatus 120. The raw data 102 is related to various factors under consideration.

For example, in the above scenario about the customer satisfaction with telecom operators, the raw data 102 may comprise observed data of a plurality of factors that are potentially related to “customer satisfaction” and may further comprise observed data of “customer satisfaction.” For example, the plurality of potentially related factors may comprise one or more of factors related to customer attributes (such as the customer level, customer phone number, and the like), factors related to customer behavior (such as monthly consumption of Internet traffic, ratio of free traffic, total monthly consumption of Internet traffic, and the like), factors related to customer feedback (such as the number of complaints, the degree of customer satisfaction, and the like), and policy factors established for the customers (such as the number of over-package reminders, timing, and the like).

Take the above scenario about the blood pressure of a patient as an example. The raw data 102 may comprise observed data of a plurality of factors that are potentially related to the “blood pressure” and observed data of the “blood pressure.” The potentially related factors may comprise the heart rate, the cardiac output, the allergy indicators, the total peripheral vascular resistance, the catecholamine release, and the like.

Take the above scenario about the commodity sales as an example. The raw data 102 may comprise expenditures of various items in the sales process of a target commodity, such as the commodity promotion, the commodity display, sales staff, advertising, new commodity marketing, and the like. Other factor data related to the target commodity (e.g., the price of the commodity, the investment in the advertising media of the commodity, and the like) may also be collected.

Take the above scenario about the software development as an example. The raw data 102 may comprise one or more of observed data of overall factors (such as the development cycle, resources invested in development, and the like) on software development and factors about various stages of software development. The factors about various stages of software development may include, for example, factors about the architecture stage (such as the software architecture method, the number of software architecture levels, and the like), factors about the coding stage (such as the code length, the number of functions, the programming language, the number of modules, and the like), factors about the testing stage (such as the correct rate or failure rate of unit testing, the correct rate or failure rate of black box testing, the correct rate or failure rate of white box testing, and the like), and factors about the running stage after the software is released (such as the correct rate or failure rate of the running stage, and the like).

In the data pre-processing stage, the data pre-processing apparatus 110 may utilize various data pre-processing techniques to process the raw data 102, and may perform related factor selection with respect to the processed raw data 102 so as to remove factors with less relevance about the causal relationships. The pre-processed data 112 provided by the data pre-processing apparatus 110 to the causal learning apparatus 120 may comprise a plurality of factors that are found from the raw data 102 to potentially have causal relationships.

The causal learning apparatus 120 is configured to learn the causal structure based on the pre-processed data 112, so as to learn causal relationships between the plurality of factors. The causal learning apparatus 120 may determine a causal structure 122 of the plurality of factors so as to indicate the causal relationships between those factors. The causal learning apparatus 120 may utilize various causal learning techniques to determine the causal structure 122. In some implementations, the causal learning apparatus 120 may delete a causal relationship with a lower confidence among the plurality of factors, and adjust the causal relationship between the plurality of factors through various optimization means and even by adding expert knowledge, so as to obtain the optimized causal structure 122.

It should be appreciated that the embodiments of the present disclosure is not intended to limit the technologies for the data pre-processing in the data pre-processing apparatus 110 and for the causal learning in the causal learning apparatus 120.

The learned causal structure 122 is provided to the attribution analysis apparatus 130. According to the embodiments of the present disclosure, the attribution analysis apparatus 130 is configured to perform attribution analysis of one or more factors to observed data of a further factor based on the causal structure 122, given the observed data 132 corresponding to the plurality of factors, so as to determine a contribution degree(s) 134 of one or more factors to target observed data of a further factor.

### Work Principle of Attribution Analysis

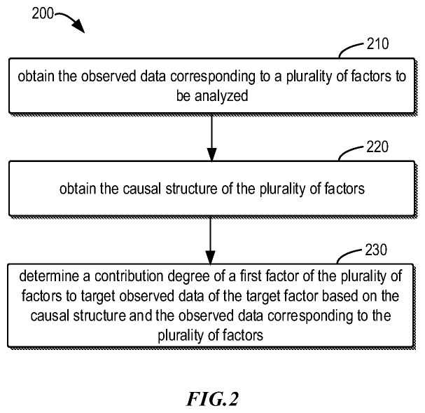

FIG. 2 illustrates a flowchart of a method 200 for attribution analysis according to some embodiments of the present disclosure. The method 200 may be, for example, performed by the attribution analysis apparatus 130 as shown in FIG. 2. For the purpose of discussion, the method 200 will be described from the perspective of the attribution analysis apparatus 130. It should be appreciated that the method 200 may further comprise additional acts which are not shown and/or may omit some acts which are shown. The scope of the present disclosure is not limited in this regard.

At block 210, the attribution analysis apparatus 130 obtains the observed data 132 corresponding to the plurality of factors to be analyzed. In some embodiments, in the environment shown in FIG. 1, for example, the attribution analysis apparatus 130 may receive a user input from the user 105 to indicate the observed data 132 that are corresponding to the plurality of factors respectively. The user 105 may directly input the observed data 132 or may specify a data source of the observed data 132 and then the attribution analysis apparatus 130 obtains the observed data 132 from the data source.

At block 220, in response to one of the plurality of factors being selected as a target factor, the attribution analysis apparatus 130 obtains the causal structure 122 of the plurality of factors.

In some embodiments, the user 105 may be allowed to directly specify the target factor among the plurality of factors to be analyzed. For example, the attribution analysis apparatus 130 may receive a user input of the user 105 to indicate the target factor. In some embodiments, the target factor may be automatically determined or randomly selected from the learned causal structure according to analysis requirements in specific scenarios.

In some embodiments, if the target factor is specified by the user or in other way, the attribution analysis apparatus 130 may determine the causal structure 122 involving the target factor from one or more learned causal structures. For example, the attribution analysis apparatus 130 may obtain the causal structure 122 from the causal learning apparatus 120. The causal structure 122 indicates causal relationships between the plurality of factors including the target factor. In the causal structure 122, the target factor is an effect factor, and the causal structure 122 further indicates a plurality of cause factors of the target factor.

In some embodiments, a plurality of cause factors having causal relationships with the target factor may be determined from a large causal graph in the result of causal learning resulting, so as to form the causal structure 122. That is, the result of causal learning may have causal relationships between more factors, and the causal structure part related to the desired target factor can be truncated for subsequent analysis.

In some embodiments, a cause factor in the causal structure 122 may have a direct causal relationship with the target factor, or may have an indirect causal relationship(s) with the target factor via one or more other cause factors. In addition to the causal relationships with the target factor, a plurality of cause factors may further have direct/indirect causal relationships. All of those relationships may be indicated by the causal structure 122.

Before introducing the specific attribution analysis, the causal structure 122 and the causal relationships it indicated are first introduced. In some embodiments of the present disclosure, the causal relationships between the plurality of factors as indicated by the causal structure 122 may comprise a linear causal relationship. The linear causal relationship indicates that: for a pair of cause factor and effect factor, a causal relationship therebetween may be represented by a linear function or a linear model. In some embodiments of the present disclosure, the causal relationships between the plurality of factors as indicated by the causal structure 122 may comprise a non-linear causal relationship. The non-linear causal relationship indicates that: for a pair of cause factor and effect factor, a causal relationship therebetween may be represented by a non-linear function or a non-linear model. In some embodiments, one or more factors in the causal structure 122 may be continuous variables, which means that observed data of such factors may have continuous values. For example, in the causal structure having a linear causal relationship, a plurality of factors may be linear continuous variables. In some embodiments, one or more factors may be discontinuous variables, which means that observed data of each of the factors may have discrete values.

Hereinafter, the linear causal relationship is mainly used as an example to describe some embodiments of the attribution analysis of the present disclosure. However, it should be appreciated that the attribution analysis of the present disclosure may be likewise applicable to the non-linear causal relationship.

The causal structure may be represented in various forms. In an embodiment, the causal structure 122 may be represented by a causal graph. The causal graph may comprise a plurality of nodes and edges connecting the plurality of nodes. The plurality of nodes may represent the plurality of factors. An edge directing connecting two nodes represents that a pair of factors corresponding to the two nodes has a direct causal relationship. In some embodiments, the causal graph may be represented as a directed acyclic graph (DAG). An edge between two nodes is a directed edge, where a starting node of the edge is the cause factor, and a node to which the arrow of the edge points is the effect factor. In the causal graph, a parent node indicates a direct causal node of a node, and a child node indicates a direct result node of the node.

An edge in the causal graph is also referred to as a “causal edge”, and a node in the causal graph is also referred to as a “causal node.” In the following example embodiments, the causal graph is mainly used as an example to illustrate the causal structure, and the terms “node” and “factor” may be used interchangeably, and the terms “edge”, “causal edge” and “a causal relationship” may also be used interchangeably. However, it should be appreciated that the causal structure may be represented in other ways as long as it can clearly indicate a plurality of factors and a causal relationship therebetween.

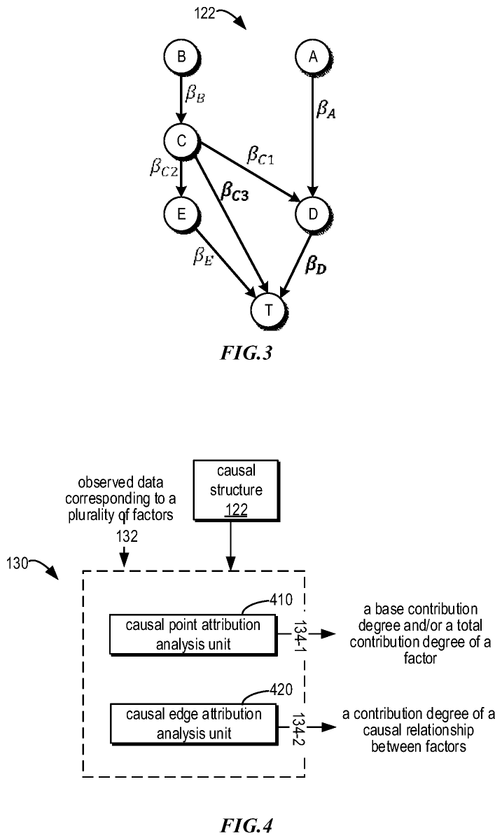

FIG. 3 illustrates an example causal structure 122 according to some embodiments of the present disclosure, which is represented by a DAG. In the example of FIG. 3, the causal structure 122 indicates causal relationships between six factors (denoted as A, B, C, D, E and F, respectively).

It should be appreciated that the number of factors in the causal structure 122 shown in FIG. 3 and a causal relationship between them are provided merely for the illustration purpose but do not suggest any limitation on the scope of the present disclosure. The causal structure according to the embodiments of the present disclosure may comprise any appropriate number of nodes or factors. It should further be understood that the factors A, B, C, D, E and F may have different meaning in different application scenarios.

For example, in the scenario about customer service, the factors A, B, C, D, E and F may comprise any of the following: the customer level, the monthly call charges, the monthly consumption of Internet traffic, the ratio of free traffic, the total monthly consumption of Internet traffic, the number of complaints, the customer satisfaction, and the like. In the scenario about patient blood pressure, the factors A, B, C, D, E and F may comprise any of the following: the heart rate, the cardiac output, the allergy indicators, the total peripheral vascular resistance, the catecholamine release, the blood pressure, and the like. In the scenario about commodity sales, the factors A, B, C, D, E and F may comprise any of the following: commodity promotion, commodity display, sales staff, advertising, new commodity marketing, commodity sales, and the like. In the scenario about software development, the factors A, B, C, D, E and F may comprise any of the following: human resources invested in software development, the duration of software development, the number of functions, the number of code lines, the number of modules, the software failure rate, and the like.

As shown in FIG. 3, the causal structure further comprises a plurality of edges (also referred to as “causal edges”) connecting the plurality of factors A, B, C, D, E and F. An edge that directly connects two factors indicates a direct causal relationship between the two factors, where one factor is a direct cause of the other factor.

For example, in FIG. 3, the edge pointing from the factor A to the factor D may indicates that the factor A is a direct cause of the factor B; the edge pointing from the factor B to the factor C may indicate that the factor B is a direct cause of the factor C; the three edges pointing from the factor C to the factors E, T and D respectively indicate that the factor C is the direct cause of the factors E, T and D; and the edges pointing from the factor E to the factor T and from the factor D to the factor T may indicate that the factors E and D are also direct causes of the factor T.

Take the linear causal relationship as an example. In the causal structure 122, a direct causal relationship between factors may be represented as a linear function. For example, the direct causal relationships between the factors A, B, C, D, E and F may be represented as:

x_{A}=u_{A}

x_{B}=u_{B}

x_{C}=β_{B}x_{B}+u_{C}

x_{D}=β_{A}x_{A}+β_{C1}x_{C}u_{D}

x_{E}=β_{C2}x_{c}+u_{E}

y_{T}=β_{D}x_{D}+β_{E}x_{E}+β_{C3}x_{C}+u_{T}

where x_{A}, x_{B}, x_{C}, x_{D}, x_{E} and y_{T} represent values of the factors A, B, C, D, E and F respectively; since the factors A and B are the only cause factors of other factors, x_{A} and x_{B} are not affected by other factors and are directly represented as u_{A} and u_{B}. For the factors C, D, E and T, their values are related to their own direct cause factors.

In the above direct causal relationships, βₖ (k∈A, B, C, D, E or T) represents a direct change rate of the effect factor with respect to the cause factor. The change rate indicates a degree of impact of change of observed data of the cause factor on observed data of the effect factor, which implies a direct causal effect value caused by the direct causal relationship between the two factors. Usually, according to the causal relationships, if observed data of the cause factor changes, observed data of the effect factor may also change. For example, β_{B} represents a direct change rate of the effect factor C with respect to the direct cause factor B; β_{A} represents a direct change rate of the effect factor D with respect to the factor A, which is one of its direct cause factors; and so on and so forth. The change rate βₖ (k∈A, B, C, D, E or T) is determined during the causal learning. In FIG. 3, the corresponding change rate βₖ (k∈A, B, C, D, E or T) is marked on an edge between a pair of directly connected nodes.

In the causal structure represented as a causal graph, in addition to the directly connected factors, a factor may also point to a further factor via one or more other factors. In this case, the factor has an indirect causal relationship with the further factor and is an indirect cause of the further factor. For example, in FIG. 3, the path from the factor A to the factor T comprises an edge pointing from the factor A to the factor D and an edge pointing from the factor D to the factor T; thus the factor A and the factor T has an indirect causal relationship, and the factor A is an indirect cause of the factor T. Similarly, the path from the factor B to the factor E comprises an edge pointing from the factor B to the factor C and an edge pointing from the factor B to the factor E; thus the factor B is an indirect cause of the factor E. The factor C not only has an edge directly pointing to the factor T but also may have two other paths, i.e., one path comprising the edge pointing from the factor C to the factor E and the edge pointing from the factor E to the factor T and another path comprising the edge pointing from the factor C to the factor D and the edge pointing from the factor D to the factor T. Therefore, the factor C further has two indirect causal relationships with the factor T via the factors E and D respectively.

Due to the presence of the indirect causal relationships, a cause factor may directly affect an effect factor and also may indirectly affect the effect factor via a further factor(s). For example, in the example causal structure of FIG. 3, it is assumed that the factor T is the target factor under consideration, and the factors A, B, C, D and E are cause factors of the factor T. The factors C, D and E directly affect the factor T, while the factors A, B and C indirectly affect the factor T via other cause factors. Therefore, when the direct cause factors (e.g., C, D and E) of the target factor A affect the factor T, the impact may include impact of other indirect cause factors. For example, the impact of the factors D on the factor T further comprises the impact of the factors A, C and B, the impact of the factors E on the factor T further comprises the impact of the factors B, C and E, and the impact of the factors C on the factor T further comprises the impact of the factor B.

Considering these possible direct and indirect impacts and different causal relationships in the causal structure, at block 230, the attribution analysis apparatus 130 determines a contribution degree 134 of a first factor of the plurality of factors to target observed data of the target factor based on the causal structure 122 and the corresponding observed data 132 of the plurality of factors. The first factor here may be any concerned factor that contributes to the target observed data, which may be any cause factor of the target factor indicated in the causal relationship 122 or may be the target factor itself

During the attribution analysis, the attribution analysis apparatus 130 may consider the impacts of the respective factors on the target factor in different ways, and further quantify the specific contributions of the factors to the target observed data of the target factor. That is, the target observed data may be considered as being generated by the target factor itself and impacts of a plurality of cause factors of the target factor. The contribution degree 134 is a quantitative indicator of the impact of the “first factor” on the target observed data. In some embodiments, the attribution analysis apparatus 130 may perform an attribution analysis on each factor or some factors in the causal structure 122. The contribution degree to the target observed data may indicate a size or proportion of the contribution of an impact of a factor on the target factor to the target observed data.

It will be discussed in detail below with reference to the accompanying drawings about how to determine different types of contribution degrees. Before giving a detailed discussion of the attribution analysis of the present disclosure, it is first introduced the theoretical findings of the attribution analysis of the present disclosure by the inventors. The attribution analysis of the present disclosure is based on counter-factual inference. A counter-fact is contrary to a fact and represents re-characterization of a distribution of facts that occurred in the past so as to construct a distribution of possibility hypotheses based on the fact.

For example, given an effect factor Y and a cause factor X, with the fact of X=x and Y=y is known, if X does not exist (e.g., (X=0)), the value of the counter-fact Y_{X=0}=y′ may be determined through counter-factual inference. It may determine that the change from the fact of y to the counter-fact y′ is due to the absence of the factor X. Accordingly, it may be considered that under the fact y, y-y′ may be attributed to x, i.e., a contribution degree of the fact x to the fact y is y-y′. This may be represented as below:

attribution(x)=y−E(Y_{X=0}|X=x,Y=y) (2)

where attribution(x) represents the contribution degree of the fact x to the fact y; E (Y_{X=0}|X=x, Y=y) represents the counter-factual inference, i.e., given the known fact X=x and Y=y, all background conditions U_{y} are summarized and all the background conditions are maintained unchanged, and then the value of Y_{X=0} (represented as y′) can be derived.

Based on the above discussion, the inventors have found that when the causal structure of the plurality of factors and the causal relationships therebetween are known, the counter-fact may be estimated so as to perform the attribution analysis for the factors. For example, it is assumed that the effect factor Y and the cause factor X are continuous variables, and the causal structure indicates that a causal relationship between them is a linear causal relationship. Given observed data y of the effect factor Y (i.e., Y=y) and observed data x of the cause factor X (i.e., X=x), by determining the change of Y caused by a unit change of the observed data x, the degree of change in y along with the change in x may be determined. This may be determined as τ=E[Y|do (x+1)]−E[Y|do(x)], where τ may be represented as the slope of x to y in a function. Then, a contribution degree of x to y may be determined as attribution(x)=y−[y+τ(0−x)]=τX, that is, the contribution degree of x to y may be represent as a product of the slope and the observed data.

Based on the above theories, in a complex causal structure involving a plurality of cause factors, it may be desirable to analyze a contribution degree of any cause factor or the target factor itself to the target observed data of the target factor. In particular, some cause factors may directly affect the target factor or may indirectly affect the target factor via one or more other cause factors. Therefore, the contribution degrees of these factors need to be further decomposed. It will be discussed in detail below the attribution analysis of the respective factors according to the embodiments of the present disclosure.

In some embodiments, in the attribution analysis, the determined contribution degree may comprise a contribution degree of the first factor to the target observed data independently of other factors in the causal structure 122. This contribution degree is referred to as a “base contribution degree” of the first factor to the target observed data, which is also referred to as a base contribution degree of the first factor for short, as the target factor is determined.

In some embodiments, additionally or alternatively, the determined contribution degree may comprise a total contribution degree of the first factor to the target observed data. In some cases, the first factor may be affected by one or more other factors (sometimes referred to as “second factors” for the purpose of discussion). That is, the first factor also has some other cause factor(s). A sum of the contribution degree of the first factor to the target observed and a contribution degree(s) of the at least one second factor to the target observed data via the first factor is referred to as a total contribution degree of the first factor to the target observed data. With the target factor provided, the total contribution degree of the first factor to the target observed data is also referred to as the total contribution degree of the first factor for short.

In some embodiments, additionally or alternatively, the determined contribution degree may comprise a relational contribution degree of a causal relationship between the first factor and a further factor (sometimes referred to as a “third factor” for the purpose of discussion) in the causal structure to the target observed data, which is also referred to as a “causal edge contribution degree.” The reason why a certain factor can affect the target observed data of the target factor is because that the factor has a direct causal relationship with the target factor, or the factor has a direct causal relationship with other factors and this direct causal relationship can further affect the target factor. Therefore, by measuring the contribution degrees of causal relationships between different factors to the target observed data of the target factor, it helps to understand the delivery path of contributions between the various factors.

The attribution analysis process in FIG. 2 may be applied to various scenarios of causal analysis as long as causal structures between the factors can be learned for the scenarios. A result of the attribution analysis may be further used to specify a policy and present a result in different scenarios.

For example, in the above scenario about customer satisfaction of telecom operators, if the attribution analysis is to be performed, then the attribution analysis apparatus 130 may obtain observed data corresponding to each factor in this scenario, which may include, for example, observed data 132 corresponding to factors such as the customer level, the monthly call charges, the monthly consumption of traffic, the ratio of free traffic, the total monthly consumption of traffic, the number of complaints, the customer satisfaction, and the like. If the user specifies “customer satisfaction” as a “target factor” to be analyzed, then the attribution analysis apparatus 130 may obtain a causal structure 122 with “customer satisfaction” being a target factor and other factors being cause factors.

Further, the attribution analysis apparatus 130 determines a contribution degree of each factor to the target observed data of the “customer satisfaction” based on the observed data 132 and the causal structure 122. For example, it is assumed that the observed value of the “customer satisfaction” is 90 points (out of 100 points). Through the attribution analysis, the attribution analysis apparatus 130 may determine a base contribution degree (e.g., 10 point) of the customer level to the 90-point customer satisfaction level in the case that the customer level is “advanced” (which may be indicated by a level “3”). Through the attribution analysis, the attribution analysis apparatus 130 may further determine a base contribution degree (e.g., 5 points) of a charge call to the 90-point customer satisfaction level in the case that the monthly call charge is 600 dollars; and so on and so forth.

Based on the attribution analysis and contribution decomposing of various factors, the user or a downstream analysis apparatus may determine the factors that have larger impact on the current customer satisfaction, the comparison between the contribution degrees of the factors, and even the difference in contribution degrees of the same factor in different statistical cycles for user satisfaction, and the like. This helps the user or the downstream analysis apparatus to determine a subsequent policy about, e.g., how to improve the user satisfaction, how to adjust total call charges and traffic cost, and the like

Take the above scenario about the blood pressure of a patient as another example. The target factor may, for example, be “blood pressure.” If the attribution analysis is to be performed, the attribution analysis apparatus 130 may obtain observed data corresponding to each factor in this scenario, e.g., the heart rate, the cardiac output, the allergy indicators, the total peripheral vascular resistance, the catecholamine release, the blood pressure, and the like. If the user specifies the “blood pressure” as a “target factor” to be analyzed, the attribution analysis apparatus 130 may obtain a causal structure 122 with the “blood pressure” being the target factor and other factors being cause factors.

Further, the attribution analysis apparatus 130 determines a contribution degree of each factor to the target observed data of the “blood pressure” based on the observed data 132 and the causal structure 122. It is assumed that the systolic blood pressure of the “blood pressure” is 140 mmHg Through the attribution analysis, the attribution analysis apparatus 130 may determine a base contribution degree of the patient's heart rate to the current systolic blood pressure, e.g., 40 mmHg in the case that the heart rate of the patient is “100 beats/minute.” Through the attribution analysis, the attribution analysis apparatus 130 may further determine a base contribution degree of the cardiac output to the current systolic blood pressure, e.g., 20 mmHg in the case that the cardiac output is 6 L/minute; and so on and so forth.

Based on the attribution analysis and contribution decomposing of various factors, the user or a downstream analysis apparatus may determine the factors that have larger impact on the current blood pressure, the comparison between the contribution degrees of the factors, and even the difference in contribution degrees of the same factor in different pressures of the same or different patients, and the like. This helps the user or the downstream analysis apparatus to determine a subsequent policy, e.g., to determine the factors that cause abnormal blood pressure, so as to determine follow-up diagnosis and treatment plans, and the like.

Take the above scenario about commodity sales as a further example. The target factor may, for example, be “sales of a target commodity.” If the attribution analysis is to be performed, the attribution analysis apparatus 130 may obtain observed data corresponding to each factor in this scenario, e.g., commodity promotion, commodity display, sales staff, advertising, new commodity marketing, commodity sales, and the like. If the user specifies the “commodity sales” as a “target factor” to be analyzed, the attribution analysis apparatus 130 may obtain a causal structure 122 with the “commodity sales” being the target factor and other factors being cause factors.

Further, the attribution analysis apparatus 130 determines a contribution degree of each factor to the target observed data of the “commodity sales” based on the observed data 132 and the causal structure 122. It is assumed that this year's “commodity sales” is 10 million. Through the attribution analysis, the attribution analysis apparatus 130 may determine base contribution degrees of the observed commodity promotion, commodity display, sales staff, advertising and new commodity marketing to the 10-million sales, e.g., how much sales out of 10 million each of them can generate.

Based on the attribution analysis and contribution decomposing of the factors, the user or a downstream analysis apparatus may determine the value transformed from the cost of each factor to the sales, the channels that have larger impact on the current sales, the comparison between contribution degrees of the factors, and even the difference in contribution degrees of the same factor in different monthly or annual sales, and the like. This helps the user or downstream analysis apparatus to determine a subsequent policy, e.g., to determine values invested to different channels, follow-up budgets of different channels, budgets invested to different channels in order to achieve expected sales, and the like

Take the above scenario about software development as a yet further example. The target factor may be, for example, “software development cycle” or “software failure rate in the running stage.” If the attribution analysis is to be performed, the attribution analysis apparatus 130 may obtain observed data corresponding to each factor in this scenario, e.g., human resources invested in software development, duration of software development, number of functions, number of code lines, number of modules, software failure rate, and the like. If the user specifies the “software failure rate” as a “target factor” to be analyzed, the attribution analysis apparatus 130 may obtain a causal structure 122 using the “software failure rate” as the target factor and other factors as cause factors.

Further, the attribution analysis apparatus 130 determines a contribution degree of each factor to the target observed data of the “software failure rate” based on the observed data 132 and the causal structure 122. It is assumed that the “software failure rate” is 3 times per month. Through the attribution analysis, the attribution analysis apparatus 130 may determine base contribution degrees of the observed human resources invested in software development, duration of software development, the number of functions, the number of code lines and number of modules to the failure rate of 3 times per month, that is, to determine a software failure rate which each of those factor may cause.

Based on the attribution analysis and contribution decomposing of various factors, the user or a downstream analysis apparatus may determine the factors that have larger impact on the software failure rate, a comparison between contribution degrees of the factors, and the like. This helps the user or downstream analysis apparatus to determine a subsequent policy, e.g., to determine from which factor the software failure rate can be effectively reduced, how to allocate the investment during the software development process, and the like

The above examples are described in the context of determining the base contribution degree of a factor. However, it should be appreciated that other types of contribution degree may also be additionally or alternatively determined, e.g., a total contribution degree and a relational contribution degree.

The observed data 132 of the plurality of factors (including the target factor and its cause factors) may be values that are directly observed or values that are desired to be observed for the plurality of factors in any application scenario. The observed data 132 may include a value of each factor at a corresponding time point. In some embodiments, the subsequent attribution analysis process may perform individual attribution analysis to the observed data at a separate time point, i.e., attribution(x)=TX.

In some embodiments, a plurality of values of each of the plurality of factors within different time ranges may also be taken into consideration, so as to achieve an overall attribution analysis. For example, a plurality of data items of each of the plurality of factors during a plurality of time ranges may be obtained. The overall attribution analysis may have different analysis types.

In an embodiment, the type of overall attribution analysis may include a type of average analysis. According to the type of average analysis, for each factor, the attribution analysis apparatus 130 averages a plurality of data items of the factor to obtain an average value corresponding to the factor as observed data of the factor. In this case, the contribution degree of each factor is represented as attribution(xₖ)=τE[Xₖ], where E[Xₖ] may be determined by calculating an average value of the plurality of data items of the factor xₖ as observed data of the factor xₖ. For example, in the scenario of commodity sales, for a plurality of factors including a plurality of channels (including promotion, commodity display, sales staff, advertising, new commodity marketing) and the sales, the cost of each channel factor and the sales in each of the past few years may be determined, and the annual average cost and annual average sales may be determined for use in subsequent attribution analysis.

In another embodiment, the type of overall attribution analysis may include a type of summing analysis. For each factor, the attribution analysis apparatus 130 may aggregate a plurality of data items of the factor and thus obtain a sum of the plurality of data items as observed data of the factor. In this case, the contribution degree of each factor is represented as attribution(xₖ)=τSum[Xₖ], where Sum[Xₖ] may be determined by calculating a sum of a plurality of data items of the factor xₖ as observed data of the factor xₖ. For example, in the scenario of commodity sales, for a plurality of factors including a plurality of channel channels (including promotion, commodity display, sales staff, advertising, new commodity marketing) and the sales, the cost of each channel factor and the sales in each month of the past year may be determined, and the annual total cost and total sales may be determined so as to be used for subsequent attribution analysis.

In some embodiments, the type of overall attribution analysis, e.g., the type of summing analysis or the type of summing analysis, may be specified by the user 105. For example, the user 105 may provide a plurality of data items of each of the plurality of factors in different time ranges and may further specify a type of analysis. The attribution analysis apparatus 130 may determine, based on the user input, observed data of each factor by averaging or aggregating the data items, and then perform subsequent attribution analysis based on the determined observed data.

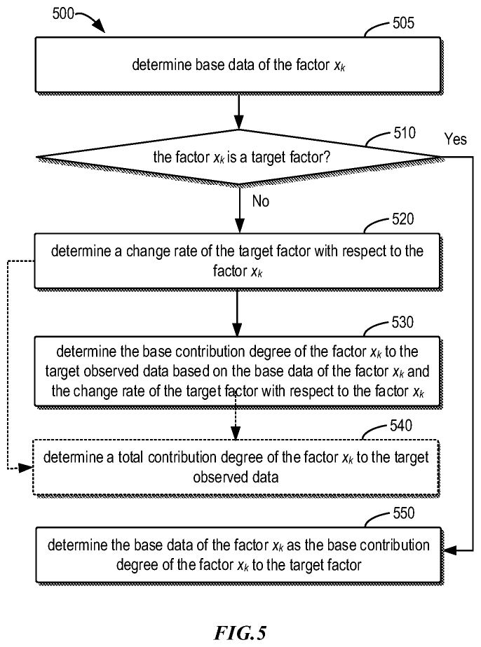

FIG. 4 illustrates a block diagram of the attribution analysis apparatus 130 according to some embodiments of the present disclosure. As illustrated, the attribution analysis apparatus 130 comprises a causal point attribution analysis unit 410 and a causal edge attribution analysis unit 420.

The causal point attribution analysis unit 410 may be configured to determine a base contribution degree(s) and/or a total contribution degree(s) of one or more factors to target observed data of a target factor. The causal edge attribution analysis unit 420 is configured to determine a contribution degree(s) of a causal relationship(s) between one or more pairs of factors to the target observed data of the target factor. The attribution analysis apparatus 130 and/or the causal edge attribution analysis unit 420 may perform corresponding attribution analysis based on the observed data corresponding to the plurality of factors and a causal result 132.

Specific examples of the causal point attribution analysis and the causal edge attribution analysis will be described with reference to flowcharts.

It should be appreciated that the units included in the attribution analysis apparatus 130 are merely exemplary and not intended to limit the scope of the present disclosure. In some embodiments, the attribution analysis apparatus 130 may further comprise additional units which are not shown and/or may omit some units which are shown. For example, in some embodiments, if a causal edge attribution analysis does not need to be performed, the causal edge attribution analysis unit 420 may be omitted. In some embodiments, the attribution analysis apparatus 130 may further comprise a result presenting unit for visually presenting the analysis results of the causal point attribution analysis unit 410 and/or the causal edge attribution analysis unit 420. In some embodiments, the causal point attribution analysis unit 410 and/or the causal edge attribution analysis unit 420 may also be divided into more functional sub-units.

### Example of Causal Point Attribution Analysis

As mentioned above, in some embodiments, for an individual factor, a base contribution degree and a total contribution degree of this factor to a target factor may be determined. The base contribution degree of a factor indicates a contribution degree of the factor to the target observed data independently without other factors. The total contribution degree of a factor indicates a sum of a contribution degree of the factor to the target observed data and a contribution degree(s) of at least one other factor to the target observed data via the factor. If a factor has a cause factor as its direct cause, then the cause factor may also affect the factor. Therefore, the impact of the factor on the target factor may include the impact of the direct cause.

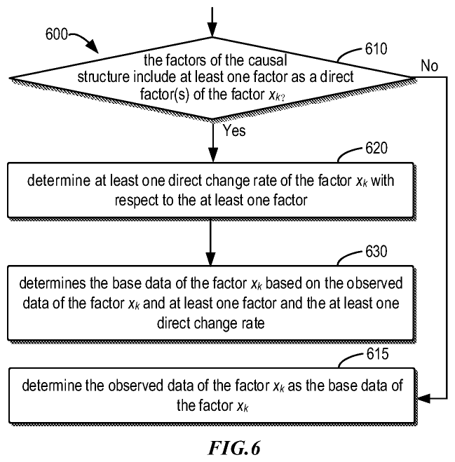

FIG. 5 illustrates a flowchart of an example method 500 for causal point attribution analysis according to some embodiments of the present disclosure. The method 500 may be performed by the attribution analysis apparatus 130 as shown in FIG. 4, e.g., by the causal point attribution analysis unit 410. For the purpose of discussion, the method 500 will be described from the perspective of the causal point attribution analysis unit 410. It should be appreciated that the method 500 may further comprise additional acts which are not shown and/or may omit some acts which are shown. The scope of the present disclosure is not limited in this regard. For example, in some embodiments, if only the base contribution degree of a factor not its total contribution degree is concerned, then block 540 may be omitted.

The method 500 may be used to determine a base contribution degree and/or a total contribution degree of any given first factor (represented by a factor xₖ) in the causal structure 122.

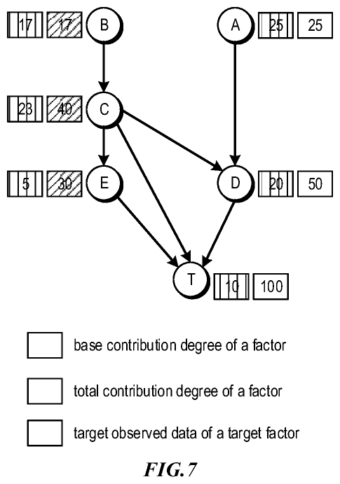

Specifically, at block 505, the causal point attribution analysis unit 410 determines base data of the factor xₖ based on the observed data 132 of the plurality of factors and the causal structure 122. Base data of a factor indicates a part of the observed data of the factor which is not affected by other factors among the plurality of factors. The determination of base data of a factor will be described in detail with reference to FIG. 6.

At block 510, the causal point attribution analysis unit 410 determines whether the factor xₖ is a target factor. If the factor xₖ is not a target factor but a cause factor of the target factor, at block 520, the causal point attribution analysis unit 410 determines a change rate of the target factor with respect to the factor xₖ based on a causal relationship between the factor xₖ and the target factor as indicated by the causal structure 122.

When decomposing the contribution of factors which are causes of the target factor, a base contribution degree of each factor to the target factor may be calculated from the base data of the factor and a change rate of the target factor with respect to the factor, because the change rate may reflect an extent to which the target observed data of the target factor changes with the observed data of the factor. Therefore, a base contribution degree of a factor to the target observed data may be represented as:

φ(xₖ)=τₓ_{ₖ}baseₓ_{ₖ} (3)

where φ(xₖ) represents the base contribution degree of the factor xₖ, baseₓₖ represents the base data of the factor xₖ, and τₓ_{ₖ} represents the change rate of the target factor with respect to the factor xₖ.

In the causal structure, a sum of the base contribution degree of the cause factor and the base contribution degree of the target factor to itself is equal to the target observed data of the target factor, for example,

$$y = {\sum }_{k} φ ( {x}_{k} ) + φ ( y ) , k ∈ n \qquad ( 4 )$$

In Equation (4), y represents the target observed data of the target factor, φ(y) represents the base contribution degree of the target factor to itself, and n represents the number of cause factors of the target factor. φ(xₖ) represents the base contribution degree of the cause factor xₖ, which may be calculated according to Equation (3).

Therefore, when the base data of each factor xₖ is determined, the base contribution degree of the factor xₖ may be determined from Equation (3) by determining the change rate τₓ_{ₖ} of the target factor with respect to the factor xₖ.

In some embodiments, if the factor xₖ is a direct cause of the target factor, then a direct change rate of the target factor with respect to the factor may be determined from the direct causal relationship indicated by the causal structure 122. For example, in the example causal structure 122 of FIG. 3, the factors D, E and C are direct causes of the target factor T, and the direct change rates are β_{D}, β_{E} and β_{C3}, respectively.

In some embodiments, the factor xₖ may not be the direct cause of the target factor but indirectly affects the target factor via one or more other factors. For example, in the example causal structure 122 of FIG. 3, the factors A, B and C may be indirect causes of the target factor T.

In the case that the factor xₖ is an indirect cause of the target factor, the change rate of the target factor with respect to the factor xₖ may be determined from a path from the factor xₖ to the target factor. Specifically, in the causal structure represented as a causal graph, the causal point attribution analysis unit 410 may determine at least one path from the factor xₖ to the target factor, each path of the at least one path comprising at least one edge of the causal graph. For example, in the example of FIG. 3, the factor A reaches the factor T via the path A→D→T; the factor B may reach the factor T via three paths B→C→D→T, B→C→E→T and B→C→T; in addition to directly reaching the factor T, the factor C indirectly reaches the factor T via the paths C→D→T and C→E→T.

Further, for each path of the at least one path, a partial change rate of the target factor with respect to the first factor on the path based on a direct change rate of an effect factor with respect to a cause factor in a direct causal relationship represented by at least one edge in the path. A partial change rate on a path may be a product of direct change rates corresponding to the edges on the path. The change rate of the target factor with respect to the factor xₖ is determined based on a sum of at least one partial change rate determined for the at least one path. For example, the partial change rate of each path may be summed up to determine the indirect change rate.

In the example of FIG. 3, since the factors A, B and C may also be indirect causes of the factor T, it may be determined that indirect change rates of the factor T with respect to these indirect causes are β_{B}β_{A} (for the factor A), (β_{D}β_{C1}+β_{E}β_{C2}+β_{C3})β_{B} (for the factor B) and (β_{D}β_{C1}+β_{E}β_{C2}+β_{C3}) (for the factor C), respectively.

At block 530, the base contribution degree of the factor xₖ to the target observed data is determined based on the base data of the factor xₖ and the change rate of the target factor with respect to the factor xₖ. For example, with reference to Equation (3), the base contribution degree of the factor xₖ may be a product of the base data of the factor xₖ and the change rate of the factor xₖ.

In the example of the causal structure shown in FIG. 3, the factors D and E are direct causes of the target factor T, the direct change rates of the factor T with respect to these direct causes are determined as β_{D} and β_{E}, respectively, and the base data of these direct causes are represented as u_{D} and u_{E}, respectively. Accordingly, the base contribution degree of the factor D to the target factor T is β_{D}u_{D}; and the base contribution degree of the factor E to the target factor T is β_{E}u_{D}.

In addition, the factors A, B and C may also be indirect causes of the factor T.

Indirect change rates of the factor T with respect to these indirect causes are determined as β_{D}β_{A} (for the factor A), (β_{D}β_{C1}+β_{E}β_{C2}+β_{C3})β_{B3} (for the factor B) and (β_{D}β_{C1}+β_{E}β_{C2}+β_{C3}) (for the factor C), respectively. The base data of A, B and C are represented as u_{A}, u_{B} and u_{c}, respectively.

Accordingly, the base contribution degree of the factor A to the target factor T is β_{D}β_{A}u_{A}; the base contribution degree of the factor B to the target factor T is (β_{D}β_{C1}+β_{E}β_{C2})β_{B}u_{B}; and the base contribution degree of the factor C to the target factor T is (β_{D}β_{C1}+β_{E}β_{C2})β_{B}u_{B}.

It is understood that the change rate of the target factor with respect to itself may be considered as 1. In some cases, the base contribution degree of the target factor with respect to itself may also be determined. For example, if at block 510 the factor xₖ is determined as the target factor, then at block 550, the causal point attribution analysis unit 410 determines the base data of the factor xₖ as the base contribution degree of the factor xₖ to the target factor. For example, in the example of FIG. 3, if the base data of the target factor T is determined as u_{T}, then the base contribution degree of the target factor to itself is also u_{T}.

In some optional embodiments, the method 500 optionally comprises block 540, where the causal point attribution analysis unit 410 determines a total contribution degree of the factor xₖ to the target observed data.

In some embodiments, the causal point attribution analysis unit 410 may determine the total contribution degree of the factor xₖ to the target observed data at least based on the base contribution degree of the factor xₖ to the target observed data.

In some embodiments, the causal point attribution analysis unit 410 may determine whether the factor xₖ has one or more direct causes. If the factor xₖ has one or more direct causes, i.e., has a parent node(s) in the causal graph, then the causal point attribution analysis unit 410 may determine at least one relational contribution degree of a direct causal relationship between the factor xₖ and the one or more factors (also referred to as “second factors, which serve as the direct causes of the factor xₖ), to the target observed data. The determination of the relational contribution degree will be discussed in detail below.

The causal point attribution analysis unit 410 may determine the total contribution degree of the factor xₖ to the target observed data based on a sum of the base contribution degree of the factor xₖ to the target observed data and the at least one relational contribution degree between the factor xₖ and the at least one second factor.

$${\sum }_{{x}_{P a} \to {x}_{k}} atrEdge ( {x}_{P a} \to {x}_{k} ) + φ ( {x}_{k} ) = atrNode ( {x}_{k} ) \qquad ( 5 )$$

where atrNode(xₖ) represents the total contribution degree of the factor xₖ, φ(xₖ) represents the base contribution degree of the factor xₖ, and atrEdge(x_{Pa}→xₖ) represents the relational contribution degree of the direct causal relationship between the factor xₖ and the factor xₚₐ (i.e., the parent node, which is its direct cause) to the target observed data. If there are a plurality of factors xₚₐ, then the relational contribution degrees of the direct causal relationships between those factors and the factor xₖ to the target observed data will be summed up.

In some embodiments, the causal point attribution analysis unit 410 may determine the total contribution degree of the factor xₖ to the target observed data at least based on the change rate of the target factor with respect to the factor xₖ and further based on the observed data of the factor xₖ. The total contribution degree of the factor xₖ to the target observed data may be a product of the change rate of the target factor with respect to the factor xₖ and the observed data of the factor xₖ.

In the example of a causal relationship in FIG. 3, the factors D and E are direct causes of the target factor T, the direct change rates of the factor T with respect to these direct causes are determined as β_{D} and β_{E} respectively, and the base data of these direct causes are represented as x_{D} and x_{E} respectively. Accordingly, the base contribution degree of the factor D to the target factor T is β_{D} x_{D}; the base contribution degree of the factor E to the target factor T is β_{E}x_{D}.

In addition, the factors A, B and C may also be indirect causes of the factor T. Indirect change rates of the factor T with respect to these indirect causes are determined as β_{D}β_{A} (for the factor A), (β_{D}β_{C1}+β_{E}β_{C2}+β_{C3})β_{B} (for the factor B) and (β_{D}β_{C1}+β_{E}β_{C2}+β_{C3}) (for the factor C), respectively. The base data of the factors A, B and C are represented as x_{A}, x_{B} and x_{C}, respectively. Accordingly, the base contribution degree of the factor A to the target factor T is β_{D}β_{A}x_{A}; the base contribution degree of the factor B to the target factor T is (β_{D}β_{C1}+β_{E}β_{C2}+β_{C3})β_{B}x_{B}; and the base contribution degree of the factor C to the target factor T is (β_{D}β_{C1}+β_{E}β_{C2}+β_{C3})x_{c}.

It is understood that the change rate of the target factor with respect to itself may be considered as 1. In some embodiments, the total contribution degree of the target factor with respect to itself may also be determined as the observed data of the target factor. For example, in the example of FIG. 3, if the observed data of the target factor T is determined as x_{T}, then the total contribution degree of the target factor T to itself is also x_{T}.

As mentioned above, in some embodiments, where observed data of a plurality of factors have been provided in the attribution analysis, the base data of a factor in the causal structure 122 may be determined so as to determine the base contribution degree of each factor. FIG. 6 illustrates a flowchart of an example method 600 for determining base data of a factor according to some embodiments of the present disclosure. The method 600 may be performed by the attribution analysis apparatus 130 as shown in FIG. 2, e.g., by the causal point attribution analysis unit 410. For the purpose of discussion, the method 600 will be described from the perspective of the causal point attribution analysis unit 410. The method 600 may further comprise an additional act which is not shown and/or may omit some acts which are shown. The scope of the present disclosure is not limited in this regard.

The base data of each factor indicates the part of observed data of the factor which is not affected by other factors among a plurality of factors. In a causal relationship, for any given factor xₖ, a factor affecting observed data of the given factor is its cause factor. Therefore, the base data of the factor xₖ may be determined as baseₓ_{ₖ}=xₖ−BX_{Pa}^{T}, where xₖ represents the observed data of the factor (the value k is from a range of all factors in the causal structure), and BX_{Pa}^{T} represents the impact of a direct cause factor of the factor xₖ on the factor xₖ. Accordingly, if there is no direct cause factor, the base data of the factor xₖ is baseₓ_{ₖ}=xₖ, i.e., the observed data of the factor.

Through the above discussion, the method 600 may be used to determine the base data of any given factor xₖ in the causal structure 130. Specifically, at block 610, the causal point attribution analysis unit 410 determines whether the plurality of factors of the causal structure 122 include at least one factor as a direct factor(s) of the factor xₖ.

If the causal structure 122 indicates that the factor xₖ does not have at least one factor as a direct cause, then at block 615, the causal point attribution analysis unit 410 determines the observed data of the factor xₖ as the base data of the factor xₖ. For example, as can be seen from the example causal structure 122 of FIG. 3, neither one of the factors A and B has a direct cause factor. Therefore, according to the direct causal relationship indicated by Equation (1), the base data of the factors A and B is equal to the observed data u_{A} and u_{B} of the factors A and B, respectively.

If the causal structure 122 indicates that the factor xₖ has at least one factor as its direct factor, then at block 620, at least one direct change rate of the factor xₖ with respect to the at least one factor is determined.

A direct change rate of a factor with respect to its cause factor is usually indicated in a direct causal relationship of the causal structure 122. For example, in the example causal structure 122 of FIG. 3, for the factor C, it is determined that the direct change rate of the factor C with respect to its direct cause factor B is β_{B}. For the factor D, it has two direct cause factors, i.e., the factors A and C. The direct change rates of the factor D with respect to the factors A and C are β_{A} and β_{C1}, respectively. Similarly, for the factors E and T which have one or more direct causes, the direct change rates of the factors E and T with respect to their respective direct cause factors may also be determined.

At block 630, the causal point attribution analysis unit 410 determines the base data of the factor xₖ based on the observed data of the factor xₖ and at least one factor, which is the direct cause of the factor xₖ, as well as the at least one determined direct change rate. Where the observed data of various factors and the direct change rates between them are known, the base data of the factor xₖ may be calculated through the direct causal relationship between the factor xₖ and a factor that serves as its direct cause.

For example, in the example causal structure 122 of FIG. 3, based on the direct causal relationship indicated by Equation (1), the base data of the factor C may be determined as u_{C}=x_{C}−β_{B}x_{B}, where x_{C} and x_{B} are the observed data of the factors C and B, respectively, and β_{B} is the direct change rate. For the other factors D, E and T, their base data may be determined similarly, which are represented as u_{D} u_{E} and u_{T}, respectively.

The method 600 may be applied to determine base data of each factor in the causal structure 122. After the base data of a plurality of factors is determined, a causal point attribution analysis for each factor may be performed, e.g., the causal point attribution analysis according to the method 500, so as to determine the base contribution degree and/or total contribution degree of each factor to the target observed data of the target factor.

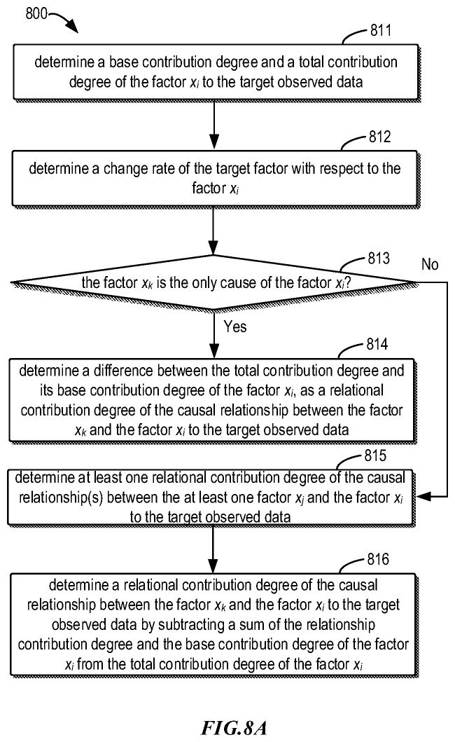

FIG. 7 illustrates an example of presenting a causal point attribution analysis result in the example causal structure 122 of FIG. 3 according to some embodiments of the present disclosure, where the base contribution degree of each of the factors A, B, C, D, E and T to the target observed data is shown. These base contribution degrees are indicated by base contribution sizes, and a sum of the base contribution degrees of all the factors A, B, C, D, E and F is equal to the observed data “100” of the target factor T. That is, the independent contribution degrees of all the cause factors and the target factor finally generate the current observed value of the target factor. In addition, FIG. 7 further illustrates respective total contribution degrees of the factors A, B, C, D and E to the target observed data “100” of the factor T. The total contribution degree of a factor comprises the base contribution degree of this factor and indirect contribution degrees of other factors to the target observed data via this factor. The total contribution degree of the target factor T to itself may be considered as the observed data of the target factor T.

### Example of Causal Edge Attribution Analysis

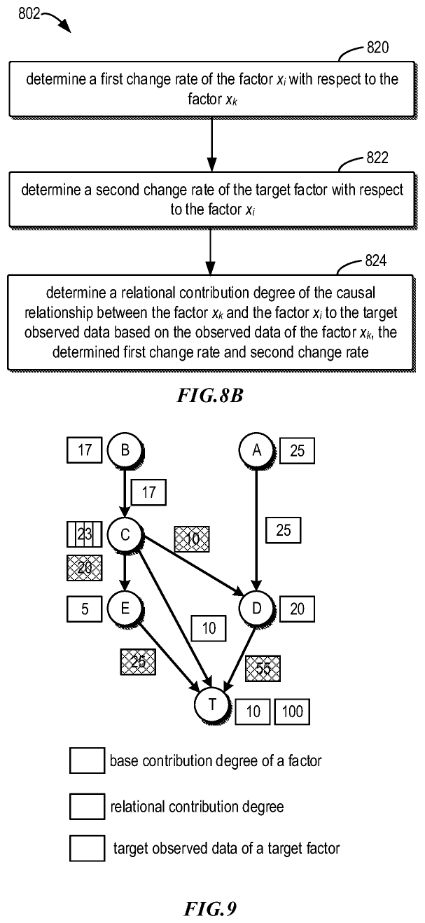

FIG. 8A illustrates a flowchart of an example method 800 for the causal edge attribution analysis according to some embodiments of the present disclosure. The method 800 may be performed by the attribution analysis apparatus 130 as shown in FIG. 2, e.g., by the causal edge attribution analysis unit 420. It should be appreciated that the method 800 may further comprise additional acts which are not shown and/or may omit some acts which are shown. The scope of the present disclosure is not limited in this regard.

During the causal edge attribution analysis, it is assumed that for a given factor xₖ, it needs to determine a relational contribution degree (represented as atrEdge(xₖ→xᵢ)) of a causal relationship between the factor xₖ and a further factor (sometimes referred to as a “third factor”, represented as a factor xᵢ) to target observed data. Therefore, the factor xₖ is a cause of the factor xᵢ in the causal relationship.

At block 811, the causal edge attribution analysis unit 420 determines a base contribution degree and a total contribution degree of the factor xᵢ to the target observed data. The base contribution degree and the total contribution degree of the factor xᵢ may be determined according to the method 500, where the determination of the total contribution degree may be based on a change rate of the target factor with respect to the factor xᵢ.

At block 812, the causal edge attribution analysis unit 420 determines a change rate of the target factor with respect to the factor xᵢ based on the causal relationship between the factor xᵢ and the target factor as indicated by the causal structure. The change rate of the target factor with respect to the factor xᵢ will also be described in detail below.

At block 813, the causal edge attribution analysis unit 420 determines whether the factor xₖ is the only cause of the factor xᵢ.

If the causal structure 122 indicates that the factor xₖ is the only cause of the factor xᵢ, then at block 814, the causal edge attribution analysis unit 420 determines a difference between the total contribution degree and its base contribution degree of the factor xᵢ that serves as a cause, as a relational contribution degree of the causal relationship between the factor xₖ and the factor xᵢ to the target observed data. According to Equation (5), the total contribution degree of the factor xᵢ is a sum of the base contribution degree of the factor xᵢ and a direct relational contribution degree of a parent node (i.e., the factor xₖ) and the factor xᵢ. Since the factor xₖ is the only cause of the factor xᵢ, i.e., there is only one parent node, Equation (5) may be modified as:

atrEdge(xₖ→xᵢ)+φ(xᵢ)=atrNode(xᵢ) (6)

With the total contribution degree and the base contribution degree of the factor xᵢ known, according to Equation (6), it may be determined that the relational contribution degree of the causal relationship between xₖ→xᵢ to the target observed data is atrEdge(xₖ→xᵢ), which is equal to the difference between the total contribution degree atrNode(xᵢ) of the factor xᵢ and its base contribution degree φ(xᵢ).

In some cases, if it is determined at block 813 that the causal structure 122 indicates at least one further factor (sometimes referred to as a “fourth factor”, represented as xⱼ) as a further cause of the factor xᵢ has, i.e., the factor xᵢ has a plurality of parent nodes, then in this case, the total contribution degree of the factor xᵢ is represented as:

$${\sum }_{{x}_{P a} \to {x}_{i}} atrEdge ( {x}_{P a} \to {x}_{i} ) + φ ( {x}_{i} ) = atrNode ( {x}_{i} ) \qquad ( 7 )$$

where the factor x_{Pa} comprises the concerned factor xₖ and further comprises the at least one further factor xⱼ.

At block 815, the causal edge attribution analysis unit 420 determines at least one relational contribution degree of the causal relationship(s) between the at least one factor xⱼ and the factor xᵢ to the target observed data based on the causal structure 122. Here the relational contribution degree may be determined based on a method similar to the method 800 or a method 802 to be described below.

At block 816, the causal edge attribution analysis unit 420 determines a relational contribution degree of the causal relationship between the factor xₖ and the factor xᵢ to the target observed data by subtracting a sum of the further relationship contribution degree and the base contribution degree of the factor xᵢ to the target observed data from the total contribution degree of the factor xᵢ to the target observed data.

When the total contribution degree of the factor xᵢ, the base contribution degree of the factor xᵢ and the relational contribution degree of the at least one further cause factor xₖ are known, the relational contribution degree atrEdge(xₖ→xᵢ) of the causal relationship between xₖ→xᵢ to the target observed data may be determined according to Equation (7), which is equal to the total contribution degree atrNode(xᵢ) of the factor xᵢ minus its base contribution degree φ(xᵢ) and further minus the further relational contribution degree of the causal relationship between the at least one factor xⱼ and the factor xᵢ to the target observed data.

FIG. 8B illustrates a flowchart of an example method 802 for the causal edge attribution analysis according to some other embodiments of the present disclosure. The method 802 may be performed by the attribution analysis apparatus 130 as shown in FIG. 2, e.g., by the causal edge attribution analysis unit 420. It should be appreciated that the method 802 may further comprise additional acts which are not shown and/or may omit some acts which are shown. The scope of the present disclosure is not limited in this regard.

During the causal edge attribution analysis, it is assumed that for a given factor xₖ, it needs to determine a relational contribution degree (represented as atrEdge(xₖ→xᵢ)) of the causal relationship between the factor xₖ and a further factor (sometimes referred to as a “third factor”, represented as a factor xᵢ) to target observed data. Therefore, the factor xₖ is the cause of the factor xᵢ in the causal relationship.

At block 820, the causal edge attribution analysis unit 420 determines a first change rate of the factor xᵢ with respect to the factor xₖ from the causal relationship between the factor xₖ and the factor xᵢ as indicated by the causal structure 122. If there is a direct causal relationship between the factor xₖ and the factor xᵢ, a direct change rate of the factor xᵢ with respect to the factor xₖ may be determined from the causal structure 122. Otherwise, an indirect change rate between the two factors may be determined by the above-discussed method.

At block 822, the causal edge attribution analysis 420 determines a second change rate of the target factor with respect to the factor xᵢ from the causal relationship between the factor xᵢ and the target factor as indicated by the causal structure 122. The direct/indirect change rate of the target factor with respect to the factor xᵢ may be determined by the above-discussed method. In some embodiments, if the factor xᵢ is the target factor, the first change rate may be considered as 1.

At block 824, the causal edge attribution analysis unit 420 determines a relational contribution degree of the causal relationship between the factor xₖ and the factor xᵢ to the target observed data based on the observed data of the factor xₖ, the first change rate and the second change rate. For example, the relational contribution degree (represented as atrEdge(xₖ→xᵢ)) may be determined as a product of the observed data of the factor xₖ, the first change rate and the second change rate, which is represented as below:

atrEdge(xₖ→xᵢ)=τₓ_{ᵢ}*(τ_{k→i}xₖ) (8)

where τ_{k→i} represents the first change rate of the factor xᵢ with respect to the factor xₖ in the causal relationship between the factor xₖ and the factor xᵢ; τₓ_{ᵢ} represents the second change rate of the target factor with respect to the factor xᵢ; and xₖ represents the observed data of the factor xₖ.

In some embodiments, in the example causal structure 122 of FIG. 3, the relational contribution degrees of the causal relationships between the respective factors to the target factor T may be determined as below:

Relational contribution degree of D→T=β_{D}x_{D};

Relational contribution degree of E→T=β_{E}x_{E};

Relational contribution degree of C→T=β_{C3}x_{c};

Relational contribution degree of A→D=β_{D}β_{A}x_{A};

Relational contribution degree of C→D=β_{D}β_{C1}x_{C}=β_{D}β_{C1}u_{C}+β_{D}β_{C1}β_{B}x_{B};

Relational contribution degree of C→E=β_{E}β_{C2}x_{C}=β_{D}β_{C2}u_{C}+β_{D}β_{C2}β_{B}x_{B};

Relational contribution degree of B→C=(β_{D}β_{C1}+β_{E}β_{C2}+β_{C3})β_{B}x_{B}.

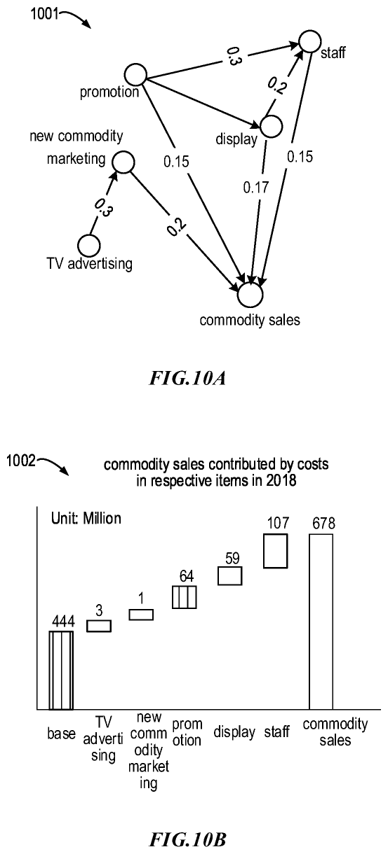

FIG. 9 illustrates an example of presenting a result of causal edge attribution analysis in the example causal structure 122 of FIG. 3 according to some embodiments of the present disclosure, where there are shown base contribution degrees of the factors and relational contribution degrees of direct causal relationships (the edges between two factors) between the factors A, B, C, D and E to the target observed data. These relational contribution degrees are indicated by contribution degree sizes. For a given factor, according to the above Equation (5), its total contribution degree to the target factor is equal to its base contribution degree plus the relational contribution degree of its direct cause node to its direct causal relationship.

### Presentation of Contribution Degrees

In some embodiments, the attribution analysis apparatus 130 may present to the user 105 the contribution degrees 134 of one or more factors to the target observed data of the target factor. The contribution degree 134 may comprise a base contribution degree of a factor, a total contribution degree of a factor, and/or a relational contribution degree of a causal relationship between the factors. This helps to provide visual information on the attribution analysis result to the user 105, so that the user can quickly capture useful information therefrom.

In some embodiments, the attribution analysis apparatus 130 may present the contribution degree 134 in association with the causal structure, which may clearly indicate the contribution degree 134 of each factor in the causal structure. In some embodiments, alternatively or additionally, the attribution analysis apparatus 130 may present the contribution degree 134 in association with the target observed data, so as to compare the observed data of the factor and its contribution degree. For example, in FIGS. 7 and 9, the contribution degree determined from the attribution analysis is presented in association with the causal structure and the observed data. In some embodiments, the attribution analysis apparatus 130 may also separately present the contribution degree 134 of each factor, e.g., in the form of a list, an icon and the like.

In some embodiments, the attribution analysis apparatus 130 may further provide more presenting ways for the contribution degree 134 of each factor according to the user selection or automatically.

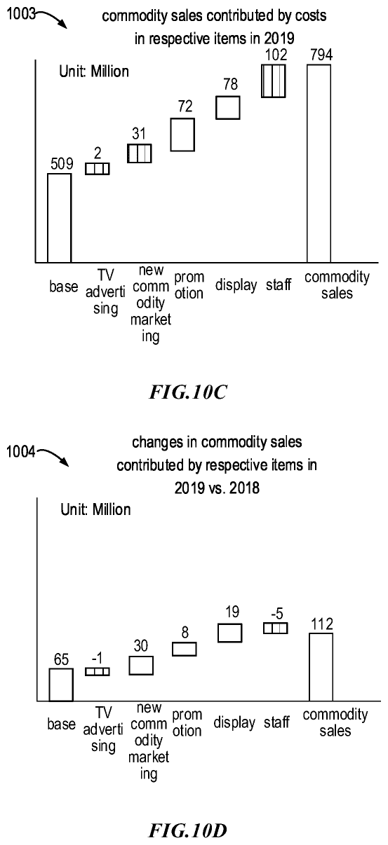

Some possible embodiments of visual presentation will be described in conjunction with FIGS. 10A to 10E.

FIG. 10A illustrates an example of a causal structure 1001 in the scenario of commodity sales. The causal structure 1001 illustrates causal relationships between TV advertising, new commodity marketing, promotion, display, staff and commodity sales. The causal structure 1001 further indicates direct change rates between to the factors (i.e., every two nodes directly connected by a directed edge) having a direct relationship.

It is assumed that the user specifies the “commodity sales” as a target factor, and the observed data of each factor in the causal structure is provided, i.e., the cost of each cause factor and the commodity sales. Then, according to the above-discussed example embodiment, the base contribution degree, the total contribution degree and the relational contribution degree of each factor may be determined.

In some embodiments, the base contribution degree, the total contribution degree and the relational contribution degree of each factor may be presented in association with the causal structure in a way similar to FIG. 7 or FIG. 9. Alternatively or additionally, the observed data of each factor may be presented.

In some embodiments, the contribution degree of each factor may be separately presented. For example, in the examples of FIGS. 10B and 10C, the base contribution degrees of commodity to annual sales in different years are presented, and the base contributions of different items (including TV advertising, new commodity marketing, promotion, display, and staff) to annual sales are also presented in the form of histograms 1002 and 1003. A sum of the base contribution degrees of all the factors including the target factor (i.e., the base sales) is equal to the annual sales.

In some embodiments, through the attribution analysis of different observed data of a plurality of factors (e.g., various items and annual sales in the two years), the change of contribution degrees of these factors under different observed data may also be presented to the user, as shown by a histogram 1004 in FIG. 10D. The histogram 1004 shows changes of base contribution degrees of different factors in 2019 as compared with 2018. It can be clearly seen that the contribution degrees of some factors increase while the contribution degrees of other factors decrease.

In some embodiments, it may be found from the causal structure that some factors have direct causal relationships and also indirect causal relationships with the target factor. It may be seen from the causal graph that these factors have direct edges and also indirect edges with the target factor. This means that the factors may directly affect the target factor but also indirectly affect the target factor through other factors. For example, in the example causal structure of FIG. 3, the factor C may directly affect the factor T and may also indirectly affect the factor T via the factors D and E. In the example of FIG. 10A, “promotion” may affect “commodity sales” directly and may also affect it via “display” and “staff.”

Generally, the total contribution degree of a factor may be equal to the relational contribution degree(s) of one or more edges starting from the factor. If an edge is directly connected with the target factor, the direct relational contribution degree of the direct causal relationship between the factor and the target factor to the target observed data may be determined. If an edge starting from the factor is indirectly adjacent to the target factor, then the indirect relational contribution degree of the indirect causal relationship between the factor and the target factor to the target observed data may be determined. Therefore, the total contribution degree of the factor xₖ is determined as:

artNode(xₖ)=direct relational contribution(xₖ)+Σindirect relational contribution(xₖ),

where, direct relational contribution(xₖ)=artEdge(x_{k→target factor}),

indirect relational contribution (xₖ)=artEdge(xₖ→xᵢ), which represents the relational contribution degree of the direct causal relationship between the factor xₖ and the factor xᵢ to the target factor and can be used to represent the indirect relational contribution degree of the factor xₖ to the target factor via the factor xᵢ.

In some embodiments, when presenting the contribution degrees, not only the total contribution degree of a factor but also the direct relational contribution degree and the indirect relational contribution degree of the factor may be represented, so that a comparison can be made between the direct and indirect contributions of the factor to the target factor.

For example, in FIG. 10A, “promotion” may affect “commodity sales” directly and may also affect “commodity sales” via “display” and “staff.” In FIG. 10E, the total contribution degree of “promotion” to “commodity sales” comprises two parts, i.e., a direct relational contribution degree 1021 of “promotion” to “commodity sales” and an indirect relational contribution degree 1022 of “promotion” to “commodity sales.” In addition, in the indirect relational contribution degree of “promotion” to “commodity sales”, a presentation 1030 may also be refined, which indicates an indirect relational contribution degree of “promotion” to “commodity sales” via “staff” and an indicate relational contribution degree of “promotion” to “commodity sales” via “display.” Therefore, for a single factor, the impact of the factor on the target factor may be analyzed from different aspects.

### Implementation of Example Device

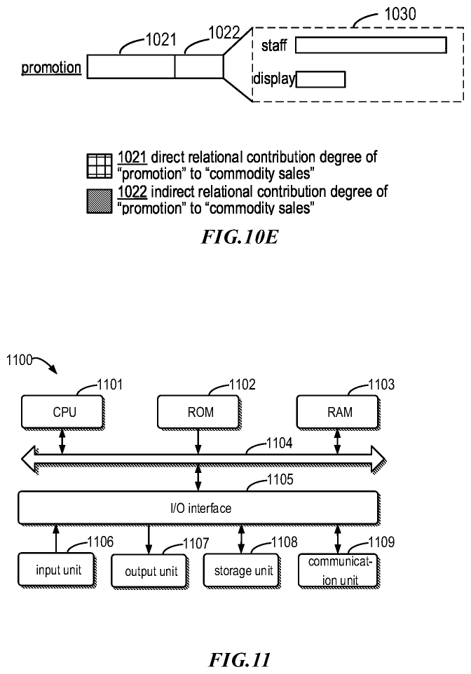

FIG. 11 illustrates a schematic block diagram of an example device 1100 that is suitable for implementing the embodiments of the present disclosure. For example, the data processing system 100 shown in FIG. 1 or components therein, e.g., the attribution analysis apparatus 130 may be implemented by the device 1100.

As illustrated, the device 1100 comprises a central processing unit (CPU) 1101 which is capable of performing various suitable actions and processes according to computer program instructions stored in a read only memory (ROM) 1102 or computer program instructions loaded from a storage unit 1108 to a random access memory (RAM) 1103. In the RAM 1103, there are also stored various programs and data required by the device 1100 when operating. The CPU 1101, the ROM 1102 and the RAM 1103 are connected to each other via a bus 1104. An input/output (I/O) interface 1105 is also connected to the bus 1104.

A plurality of components in the device 1100 are connected to the I/O interface 1105, including: an input unit 1106 including a keyboard, a mouse, or the like; an output unit 1107, such as various types of displays, a loudspeaker or the like; a storage unit 1108, such as a disk, an optical disk or the like; and a communication unit 1109, such as a LAN card, a modem, a wireless communication transceiver or the like. The communication unit 1109 allows the device 1100 to exchange information/data with other devices via a computer network, such as the Internet and/or various telecommunication networks.

The above-described procedures and processes, such as the methods 200, 500, 600, 800 and/or 802, may be executed by the processing unit 1101. For example, in some embodiments, the methods 200, 500, 600, 800 and/or 802 may be implemented as a computer software program, which is tangibly embodied on a machine readable medium, e.g. the storage unit 1108. In some embodiments, a part or all of the computer program may be loaded to and/or installed on the device 1100 via the ROM 1102 and/or the communication unit 1109. The computer program, when loaded to the RAM 1103 and executed by the CPU 1101, may execute one or more acts of the methods 200, 500, 600, 800 and/or 802 as described above.

The embodiments of the present disclosure may be implemented as a system, device, method, a computer-readable storage medium, and/or a computer program product.

In some embodiments of the present disclosure, a computer-readable storage medium is provided, with computer-executable instructions or program stored thereon which are/is executed by a processor to perform the above-described methods or functions. The computer-readable storage medium may comprise a non-transient computer-readable medium. In some embodiments of the present disclosure, a computer program product is further provided, including a computer program/instructions which, when executed by a processor, performs the above-described methods or functions. The computer program product may be tangibly embodied on a non-transient computer-readable medium.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., optical pulses through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, apparatuses (systems), and computer program products according to embodiments of the invention. It should be understood that each block of the flowcharts and/or block diagrams, and combinations of blocks in the flowcharts and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, the other programmable apparatus or other device to produce a computer implemented process, such that the instructions executed thereon can implement the functions/acts specified in one or more blocks in the flowcharts and/or block diagrams.

The flowcharts and block diagrams in the figures illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in sequence may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The descriptions of the various embodiments of the present disclosure have been presented for the purposes of illustration, but are not intended to be exhaustive or limited to embodiments disclosed. Various modifications and variations will be apparent to those ordinary skilled in the art without departing from the scope and spirit of the described embodiments. The terminology used herein is chosen to best explain the principles of embodiments, the practical application or technical improvement over technologies found in the marketplace, or to enable other ordinary skilled in the art to understand the embodiments disclosed herein.

1-17. (canceled)

18. A method for data processing, comprising:
obtaining observed data corresponding to a plurality of factors to be analyzed;
in response to one of the plurality of factors being selected as a target factor, obtaining a causal structure of the plurality of factors, the causal structure indicating causal relationships between the plurality of factors; and
determining a contribution degree of a first factor of the plurality of factors to target observed data of the target factor based on the causal structure and the observed data corresponding to the plurality of factors.

19. The method of claim 18, wherein obtaining the observed data corresponding to the plurality of factors comprises:
receiving a first user input specifying the observed data corresponding to the plurality of factors.

20. The method of claim 18, wherein obtaining the observed data corresponding to the plurality of factors comprises:
receiving a second user input specifying a type of analysis and a plurality of data items of each of the plurality of factors within a plurality of time ranges; and
in accordance with a determination that the type of analysis is a type of average analysis, averaging the plurality of data items of each of the plurality of factors to determine observed data of the factor; and
in accordance with a determination that the type of analysis is a type of summing analysis, aggregating the plurality of data items of each of the plurality of factors to determine observed data of the factor.

21. The method of claim 18, wherein determining the target factor comprises:
receiving a third user input specifying the target factor.

22. The method of claim 18, wherein determining a contribution degree of the first factor to the target observed data comprises: determining at least one of
a base contribution degree of the first factor to the target observed data independently of other factors among the plurality of factors,
a total contribution degree of the first factor to the target observed data, the total contribution degree indicating a total sum of contribution degrees of the first factor to the target observed data and at least one second factor of the plurality of factors to the target observed data via the first factor, and
a relational contribution degree of a causal relationship between the first factor and a third factor of the plurality of factors to the target observed data.

23. The method of claim 18, further comprising:
presenting the contribution degree of the first factor to the target observed data to a user by at least one of:
presenting the contribution degree in association with the causal structure,
presenting the contribution degree in association with the target observed data, and
separately presenting the contribution degree.

24. The method of claim 22, wherein determining the base contribution degree of the first factor to the target observed data comprises:
determining base data of the first factor based on the observed data of the plurality of factors and the causal structure, the base data of the first factor indicating a portion of the observed data of the first factor that is not affected by other factors among the plurality of factors;
in accordance with a determination that the first factor is not the target factor,
determining a change rate of the target factor with respect to the first factor based on a causal relationship between the first factor and the target factor as indicated by the causal structure, and
determining the base contribution degree of the first factor to the target observed data based on the base data of the first factor and the change rate of the target factor with respect to the first factor; and
in accordance with a determination that the first factor is the target factor, determining the base data of the first factor as the base contribution degree of the first factor to the target observed data.

25. The method of claim 24, wherein the causal structure is indicated by a causal graph comprising a plurality of nodes that represent the plurality of factors and edges that connect the plurality of nodes, and an edge directly connecting a pair of nodes among the plurality of nodes represents a direct causal relationship between a pair of factors corresponding to the pair of nodes, and wherein determining the change rate of the target factor with respect to the first factor comprises:
determining, from the causal graph, at least one path from the first factor to the target factor, each of the at least one path comprising at least one edge in the causal graph;
for each of the at least one path, determining a partial change rate of the target factor with respect to the first factor on the path based on a direct change rate of an effect factor with respect to a cause factor in a direct causal relationship represented by at least one edge included in the path; and
determining a change rate of the target factor with respect to the first factor based on a sum of at least one partial change rate determined for the at least one path.

26. The method of claim 24, wherein determining the base data of the first factor comprises:
in accordance with a determination that the causal structure indicates that the plurality of factors comprise at least one factor as a direct cause of the first cause,
determining, from a direct causal relationship between the at least one factor and the first factor as indicated by the causal structure, at least one direct change rate of the first factor with respect to the at least one factor, and
determining base data of the first factor based on observed data of the first factor and the at least one factor and the at least one determined direct change rate; and
in accordance with a determination that the causal structure indicates that the plurality of factors comprise no factor as a direct cause of the first factor, determining observed data of the first factor as base data of the first factor.

27. The method of claim 22, wherein the causal structure indicates that the at least one second factor is a direct cause of the first factor, and determining the total contribution degree of the first factor to the target observed data comprises:
determining at least one relational contribution degree of a direct causal relationship between the at least one second factor and the first factor to the target observed data;
determining a base contribution degree of the first factor to the target observed data; and
determining the total contribution degree of the first factor to the target observed data based on a sum of the base contribution degree of the first factor to the target observed data and the at least one relational contribution degree.

28. The method of claim 22, wherein the causal structure indicates that the first factor is a cause of the third factor, and determining the relational contribution degree of the causal relationship between the first factor and the third factor to the target observed data comprises:
determining a base contribution degree and a total contribution degree of the third factor to the target observed data;
determining a change rate of the target factor with respect to the third factor based on a causal relationship between the third factor and the target factor as indicated by the causal structure; and
in accordance with a determination that the causal structure indicates that the first factor is an only cause of the third factor, determining a difference between the total contribution degree and the base contribution degree of the third factor as the relational contribution degree of the causal relationship between the first factor and the third factor to the target observed data.

29. The method of claim 28, wherein determining the relational contribution degree of the causal relationship between the first factor and the third factor to the target observed data further comprises:
in accordance with a determination that the causal structure indicates that at least one fourth factor is a further cause of the third factor,
determining, based on the causal structure, a further relational contribution degree of a causal relationship between the at least one fourth factor and the third factor to the target observed data; and
determining the relational contribution degree of the causal relationship between the first factor and the third factor to the target observed data by subtracting a sum of the further relational contribution degree and the base contribution degree of the third factor to the target observed data from the total contribution degree of the third factor to the target observed data.

30. The method of claim 22, wherein the causal structure indicates that the first factor is a cause of the third factor, and determining the relational contribution degree of the causal relationship between the first factor and the third factor to the target observed data comprises:
determining a first change rate of the third factor with respect to the first factor from a causal relationship between the first factor and the third factor as indicated by the causal structure;
determining a second change rate of the target factor with respect to the third factor from a causal relationship between the third factor and the target factor as indicated by the causal structure; and
determining the relational contribution degree of the causal relationship between the first factor and the third factor to the target observed data based on observed data of the first factor, the first change rate, and the second change rate.

31. The method of claim 18, wherein the causal relationship comprises a linear causal relationship.

32. An electronic device, comprising:
at least one processing unit; and
at least one memory coupled to the at least one processing unit and storing instructions executable by the at least one processing unit, the instructions, when executed by the at least one processing unit, causing the device to perform acts comprising:
obtaining observed data corresponding to a plurality of factors to be analyzed;
in response to one of the plurality of factors being selected as a target factor, obtaining a causal structure of the plurality of factors, the causal structure indicating causal relationships between the plurality of factors; and
determining a contribution degree of a first factor of the plurality of factors to target observed data of the target factor based on the causal structure and the observed data corresponding to the plurality of factors.

33. The electronic device of claim 32, wherein obtaining the observed data corresponding to the plurality of factors comprises:
receiving a first user input specifying the observed data corresponding to the plurality of factors.

34. The electronic device of claim 32, wherein obtaining the observed data corresponding to the plurality of factors comprises:
receiving a second user input specifying a type of analysis and a plurality of data items of each of the plurality of factors within a plurality of time ranges; and
in accordance with a determination that the type of analysis is a type of average analysis, averaging the plurality of data items of each of the plurality of factors to determine observed data of the factor; and
in accordance with a determination that the type of analysis is a type of summing analysis, aggregating the plurality of data items of each of the plurality of factors to determine observed data of the factor.

35. The electronic device of claim 32, wherein determining the target factor comprises:
receiving a third user input specifying the target factor.

36. The electronic device of claim 32, wherein determining a contribution degree of the first factor to the target observed data comprises: determining at least one of
a base contribution degree of the first factor to the target observed data independently of other factors among the plurality of factors,
a total contribution degree of the first factor to the target observed data, the total contribution degree indicating a total sum of contribution degrees of the first factor to the target observed data and at least one second factor of the plurality of factors to the target observed data via the first factor, and
a relational contribution degree of a causal relationship between the first factor and a third factor of the plurality of factors to the target observed data.

37. A computer-readable storage medium having computer-executable instructions stored thereon which are executed by a processor to perform acts comprising:
obtaining observed data corresponding to a plurality of factors to be analyzed;
in response to one of the plurality of factors being selected as a target factor, obtaining a causal structure of the plurality of factors, the causal structure indicating causal relationships between the plurality of factors; and
determining a contribution degree of a first factor of the plurality of factors to target observed data of the target factor based on the causal structure and the observed data corresponding to the plurality of factors.
